(19) United States
(12) Patent Application Publication
(10) Pub. No.: US 2004/0092186 A1
(43) Pub. Date: May 13, 2004

(54) Textile electronic connection system

(76) Inventors: Patricia Wilson-Nguyen, West Arlington, MA (US); Brian Farrell, Quincy, MA (US); Justyna Teverovsky, Acton, MA (US); Jeremiah R. Slade, Arlington, MA (US); Douglas T. Thomson, Hanover, MA (US); Barry Brindle, Vinton, VA (US)

Correspondence Address: IANDIORIO & TESKA, INTELLECTUAL PROPERTY LAW ATTORNEYS, 260 BEAR HILL ROAD, WALTHAM, MA, 02451-1018, US

(21) Appl. No.: 10/615,470

(22) Filed: Jul. 8, 2003

Related U.S. Application Data
(63) Continuation-in-part of application No. 09/715,496, filed on Nov. 17, 2000.
(60) Provisional application No. 60/394,700, filed on Jul. 9, 2002.

(51) Int. Cl. D03D 15/00; H01R 13/627

(52) U.S. Cl. 442/181; 439/352

(57) ABSTRACT

A textile electronic connection system wherein a knitted, woven, or braided textile ribbon includes integrated transmission elements running the length of the ribbon to transmit data and/or power along the length of the ribbon. A fastener connects the ribbon to another ribbon or device and includes a male portion and a female portion. One of the male portion and the female portion is on one end of the ribbon and the other of the male portion and the female portion is on the other ribbon or device. At least one of the male portion and the female portion includes a deformable element which releasably locks the male and female portions together. A connector is integrated with the fastener portions and connected to the integrated transmission elements to quickly allow connection and disconnection of the ribbon to the other ribbon or device in a robust and reliable fashion.

### RELATED APPLICATIONS

This application claims priority of provisional application Serial No. 60/394,700 filed Jul. 9, 2002. This application is a continuation-in-part application of co-pending application Ser. No. 09/715,496 filed Nov. 17, 2000 (now allowed).

### FIELD OF THE INVENTION

This invention relates to a textile electronic connection system.

### BACKGROUND OF THE INVENTION

The applicants' co-pending, now allowed, U.S. patent application Ser. No. 09/715,496, included herein by this reference, discloses a flat textile ribbon including integrated transmission elements as a viable alternative to so-called broad loom wearable electronic fabrics.

Physically and electrically connecting two lengths of such a ribbon together in a ruggedly releasable fashion, however, is not an elementary endeavor.

Standard connectors for ribbon cables are not always compatible with military specifications or other commercial connectors and there does not exist, based on our knowledge, a suitable connector which can be quickly attached without any tools, which is secure, which can be quickly released, and which is reliable over time and after many connects/disconnects.

These requirements are especially important in military and in other fields where the connector will be subject to abuse and may even be repeatedly subjected to washing.

### SUMMARY OF THE INVENTION

It is therefore an object of this invention to provide a textile electronic connection system.

It is a further object of this invention to provide such a system which is highly reliable.

It is a further object of this invention to provide such a system which provides both a physical and an electrical connection without the use of any tools.

It is a further object of this invention to provide such a system which, in the connected state, is secure.

It is a further object of this invention to provide such a system which can be quickly released.

It is a further object of this invention to provide such a system which is durable.

The invention results from the realization that a more durable and rugged textile electronic connection system is effected by the integration of a quick release type physical fastener with an electrical and/or optical connector which can take many different forms to provide a quick, reliable, and durable connect/disconnect without any tools.

This invention features a textile electronic connection system comprising a knitted, woven, or braided textile ribbon including integrated transmission elements running the length of the ribbon to transmit data and/or power along the length of the ribbon and a fastener for connecting the ribbon to another ribbon or device. The fastener includes a male portion and a female portion. One of the male portion and the female portion is on one end of the ribbon and the other of the male portion and the female portion is on the other ribbon or device. At least one of the male portion and the female portion includes a deformable element which releasably locks the male and female portions together. A connector is integrated with the fastener portions and connected to the integrated transmission elements to quickly allow connection and disconnection of the ribbon to the other ribbon or device in a robust and reliable fashion.

In one embodiment, the male portion of the fastener includes deformable prongs and the female portion of the fastener includes recesses which receive the prongs. In one example, one portion of the connector is disposed between the deformable prongs of the male portion of the fastener and the other portion of the connector is disposed between the recesses of the female portion of the fastener. A guide channel may be provided in the female portion of the fastener about the connector portion for guiding the connector portions together. The guide channel may be configured to accept the female portion of the connector in only one orientation. The connector may be a USB connector, a Lemo connector, or any other kind of connector.

In another example, the connector includes conductive portions of the prongs of the male fastener portion and corresponding conductive portions of the female fastener portion. A pin may be included with the male portion of the fastener and a receptacle in the female portion of the fastener deformably accepts the pin therein.

In another example, the male fastener portion includes a pair of legs and the female fastener portion includes a pair of tubes which receive the legs. Typically, connector includes a portion overmolded onto the ribbon for added durability.

In another embodiment, the fastener is a conductive snap. The female snap portion includes at least one recess and the male snap portion includes at least one extension deformably received in the recess. Typically, at least one insulator divides the snap into at least two terminals. In one example, there is one centrally located extension and one centrally located recess and the insulator divides the recess into two terminals and the extension into two corresponding terminals. In another example, the male portion includes a circumferential insulator dividing the male portion into inner and outer terminals and the female portion includes a circumferential insulator dividing the female portion into corresponding inner and outer terminals. In one embodiment, the male portion includes a plurality of extensions, at least two associated with different terminals and the female portion includes a plurality of recesses each of which accept an extension. In another example, there are a plurality of circumferential insulators coaxially aligned.

Thus, one textile electronic connection system in accordance with this invention includes a male fastener portion including deformable prongs and one portion of a connector between the deformable prongs. A female fastener portion includes recesses which receive the prongs of the male fastener portion and the female fastener portion includes the other portion of the connector disposed between the recesses of the female fastener portion.

Another textile electronic connection system in accordance with this invention includes a male fastener portion including prongs with a conductive portion thereon and a female fastener portion including recesses which receive the prongs of the male portion and having corresponding conductive portions contacting the conductive portions of the prongs of the male fastener portion to provide an electrical interconnection between the male and female fastener portions. Still another textile electronic connection system in accordance with this invention includes a male fastener portion including legs with the conductive portion thereon and a female fastener portion including tubes which receive the legs of the male portion and having corresponding conductive portions contacting the conductive portions of the legs of the male fastener portion to provide an electrical interconnection between the male and female fastener portions.

In accordance with the subject invention, a first knitted, woven, or braided textile ribbon includes integrated transmission elements running the length of the ribbon to transmit data and/or power along the length of the ribbon and a second knitted, woven, or braided textile ribbon also includes integrated transmission elements running the length of the ribbon to transmit data and/or power along the length of the ribbon. A fastener physically and electrically interconnects the two ribbons. A male fastener portion is connected to the first ribbon and a female fastener portion is connected to the second ribbon. At least one of the male fastener portion and the female fastener portion includes a deformable element which locks the male and female portions together. One connector portion is integrated with the male fastener portion and connected to the integrated transmission elements of the first ribbon and the other connector portion is integrated with the female portion of the fastener and connected to the integrated transmission elements of the second ribbon.

In accordance with one specific embodiment a male fastener portion overmolded onto one end of the first ribbon and a female fastener portion overmolded onto one end of the second ribbon. At least one of the male fastener portion and the female fastener portion including a deformable element which locks the male and female portions together. One connector portion is integrated with the male fastener portion and connected to the integrated transmission elements of the first ribbon and the other connector portion is integrated with the female portion of the fastener and connected to the integrated transmission elements of the second ribbon.

In accordance with another embodiment, a male fastener portion is connected to the first ribbon and includes a pair of deformable prongs. A female fastener portion is connected to the second ribbon and includes a pair of recesses which receive the prongs. One connector portion is between the prongs of the male fastener portion and connected to the integrated transmission elements of the first ribbon. The other connector portion is between the recesses of the female portion of the fastener and connected to the integrated transmission elements of the second ribbon.

In accordance with another embodiment, a fastener physically and electrically interconnects the two ribbons and includes a male fastener portion connected to the first ribbon with a pair of deformable prongs. A female fastener portion is connected to the second ribbon and includes a pair of recesses which receive the prongs. One connector portion is on the prongs of the male fastener portion and connected to the integrated transmission elements of the first ribbon and the other connector portion is integrated with the female portion of the fastener and connected to the integrated transmission elements of the second ribbon.

In another embodiment, the fastener includes a male fastener portion with a pair of legs and a female fastener portion including a pair of tubes which receive the legs of the male fastener portion. One connector portion is integrated with the legs of the male fastener portion and connected to the integrated transmission elements of the first ribbon and the other connector portion is integrated with the tubes of the female portion of the fastener and connected to the integrated transmission elements of the second ribbon. In still another embodiment, the fastener includes a male snap member connected to the first ribbon and including extension. A female snap member is connected to the second ribbon including a recess which receives the extension of the male snap member. One connector portion is integrated with the male snap member and connected to the integrated transmission elements of the first ribbon and the other connector portion is integrated with the female snap member of the fastener and connected to the integrated transmission elements of the second ribbon. Typically, an insulator divides the male snap member into two terminals and another insulator divides the female snap member into two terminals.

### BRIEF DESCRIPTION OF THE DRAWINGS

Other objects, features and advantages will occur to those skilled in the art from the following description of a preferred embodiment and the accompanying drawings, in which:

FIG. 1 is a schematic view of one embodiment of a textile electronic connection system in accordance with the subject invention;

FIG. 2 is a schematic, exploded three dimensional view of the fastener and connector portions of the system shown in FIG. 1;

FIG. 3 is a three-dimensional schematic view showing the male portion of the fastener of FIGS. 1-2 just before it is received in the female portion of the fastener;

FIG. 4 is a schematic three-dimensional top view showing the male fastener of FIG. 3 in place within the female portion of the fastener;

FIG. 7 is a schematic three-dimensional view showing an embodiment of the textile electronic connection system of the subject invention interconnecting two electronic subsystems;

FIG. 8 is a schematic three-dimensional view showing a portion of another embodiment of an integrated fastener/connector in accordance with the subject invention;

FIGS. 9A and 9B are schematic views showing an integrated fastener/connector in accordance with this invention wherein the male portion is accepted in the female portion in only one orientation;

FIG. 10 is a schematic top view showing another embodiment of the female portion of a connector system in accordance with the subject invention;

FIG. 11 is a schematic top view of the male fastener component received in the female component shown in FIG. 10;

FIG. 12 is a schematic cross-sectional side view of another snap type embodiment for a textile electronic connection system in accordance with the subject invention;

FIG. 13 is a top view of the male snap portion shown in FIG. 12;

FIG. 14 is a top view of the bottom snap portion shown in FIG. 12;

FIG. 15 is a schematic top view showing the male snap engaged with the female snap and both connected to different ribbon portions in accordance with the subject invention;

FIG. 16 is a schematic top view of another snap connector type system in accordance with the subject invention;

FIG. 17 is a side view of the male portion of the snap system shown in FIG. 16;

FIG. 18 is a schematic side view of the female portion of the snap shown in FIG. 16;

FIG. 19 is a top view of still another embodiment of a snap type textile electronic connection system in accordance with the subject invention;

FIG. 20 is a schematic side view of still another embodiment of a textile electronic connection system in accordance with the subject invention;

FIG. 21 is a schematic top view showing still another embodiment of a snap type fastener/electrical connector in accordance with the subject invention;

FIG. 22 is a schematic top view of still another embodiment of a snap type fastener/connector system in accordance with the subject invention; and

FIG. 23 is a schematic view showing a coaxial connector snap constuction

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

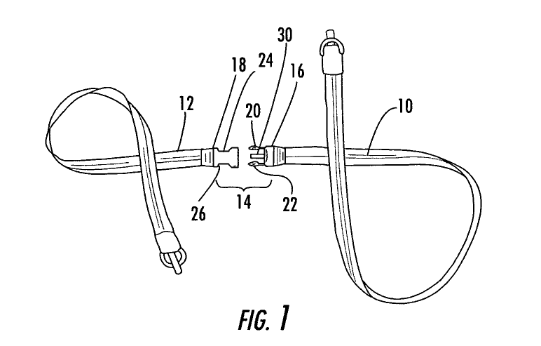

In accordance with one embodiment of the subject invention, knitted, woven, or braided textile ribbon 10, FIG. 1 includes integrated transmission elements running the length of the ribbon to transmit data and/or power along the length of the ribbon as delineated in co-pending (now allowed) patent application Ser. No. 09/715,496 incorporated herein by this reference. Ribbon 10 is releasably connected to second ribbon 12 of a similar type or to another device (e.g., a processing unit, sensor unit, or the like) by integrated fastener/connector 14. Fastener 14 includes male portion 16 and female portion 18. In the example shown, male portion 16 is connected to one end of ribbon 10 and female portion 18 is connected to one end of ribbon 12 as shown. Male portion 16 includes deformable prongs 20 and 22 received in recesses 24 and 26 of female portion 18 providing a rugged physical “Fastex” type connection. Male (or female) connector portion 30, FIGS. 2-4 is integrated with the fastener and connected to the integral transmission elements of ribbon 12. Corresponding female (or male) portion 32 of the connector is also integrated with the fastener and connected to the integral transmission elements of ribbon 10. In this example, the, connector is a Lemo connector but may also be a USB connector or any other type of connector (e.g., firewire, coaxial, RGB, SMA, and the like). Preferably, overmolded portions 40 and 42 ruggedly connect the male 16 and female 18 fastener portions to ribbons 10 and 12, respectively, and provide strain relief.

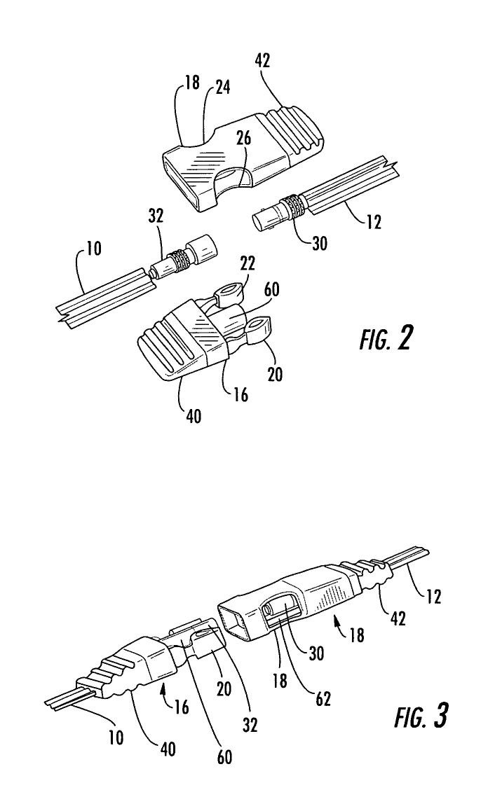

The result is an integrated fastener/connector assembly which is quickly attached without any tools, which is secure in the connected configuration, and which can be quickly released (by pressing inward on deformable prongs 20 and 22, FIG. 4). In the connected position shown in FIG. 3, the electrical and physical connection provided by the system of this invention is secure and able to withstand field maneuvers by military personnel and be worn, for example, by even mountain climbers, cyclers, and other outdoor enthusiasts. In but one example, ribbons 10 and 12 interconnect two subsystems located on different parts of the a person's body, for example, a processor and a display. In one sense, the fastener portions protect the electrical or optical connector. Care must be taken to properly secure the ribbon within the overmolding mold cavity. In one example, set pins were added to the mold cavity to hold the ribbon in place in the mold cavity.

As shown in FIG. 5, fastener portions 16 and 18 reliably secure connector portions 30 and 32 together and connector portions 30 and 32 interconnect the transmission elements (e.g., conductors or wires) 50, 52 of ribbons 12 and 10, respectively, to provide a power or data link. Soldering, crimping, or conductive adhesives may serve to connect the transmission elements to their respective connector half. The ribbons with their respective connectors can be washed repeatedly and thus serve as a reliable connect/disconnect system.

Referring again to FIGS. 2-3, male fastener portion 16 may include housing or ferrule 60 which receives female connector 32 positioning it between prongs 20 and 22. Female fastener portion 18, in turn, may include guide channel 62, FIG. 3 between recesses 24 and 26 which receive housing 60 and guides connector portion 32 over connector portion 30 to provide a positive engagement of the two connector halves.

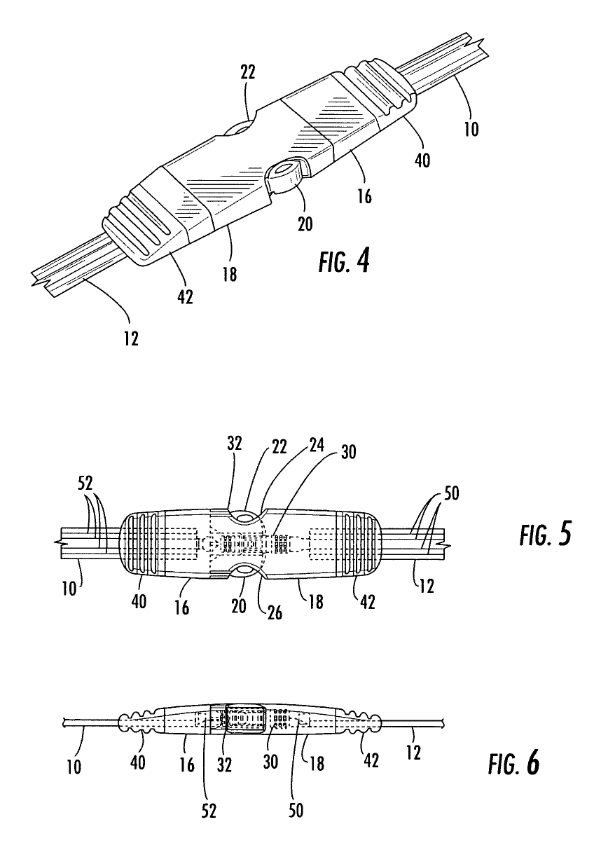

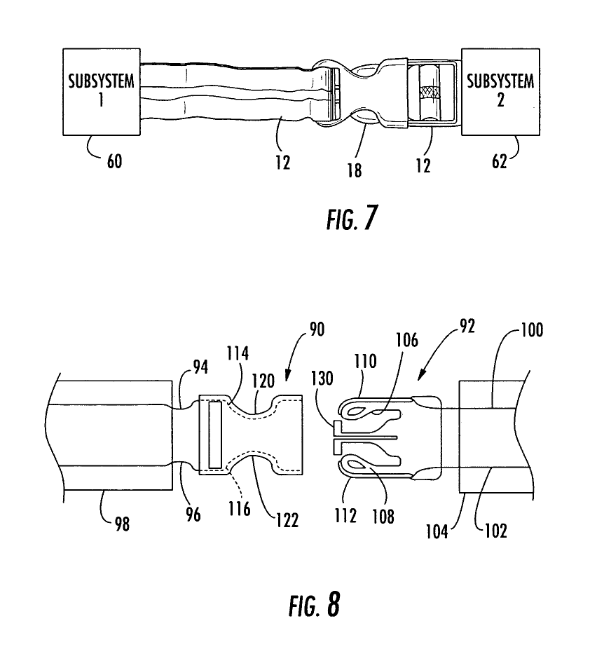

As shown in FIG. 7, subsystem 60 is releasably connected to subsystem 62 by ribbon 12 and connector portions 18 (female) and 12 (male). Subsystems 60 and 62 may be one of a power source, electrical device, electronic system, electronic or electrical device, an optical device, a sensor, and combinations of the same.

In the embodiment shown in FIG. 8, female fastener portion 90 and male fastener portion 92 interconnect conductors 94 and 96 of ribbon 98 to conductors 100 and 102 of ribbon 104 in the following manner. Prongs 106 and 108 of male fastener portion 92 include conductive portions (e.g., traces) 110 and 112, respectively, which are electrically connected to conductors 100 and 102, respectively, of ribbon 104. Corresponding conductive portions 114 and 116 of female fastener portion 90 are electrically connected to conductors 94 and 96 of ribbon 98. Thus, for example, when male fastener portion 92 is releasably locked within female fastener portion 90 by the action of deformable prongs 106 and 108 biasing outward into position in recesses 120 and 122, conductor 94 of ribbon 98 is electrically connected to conductor 100 of ribbon 104 through conductive portion 114 of female fastener portion 90 which contacts conductive male portion 110 of female fastener portion 92. The plastic portions of the fastener between the conductive portions provide electrical isolation between the two conductive pathways.

Tang member 130 of male fastener portion 92 is received in a channel (not shown) centrally disposed in female fastener portion 90 to guide male portion 92 within female portion 90.

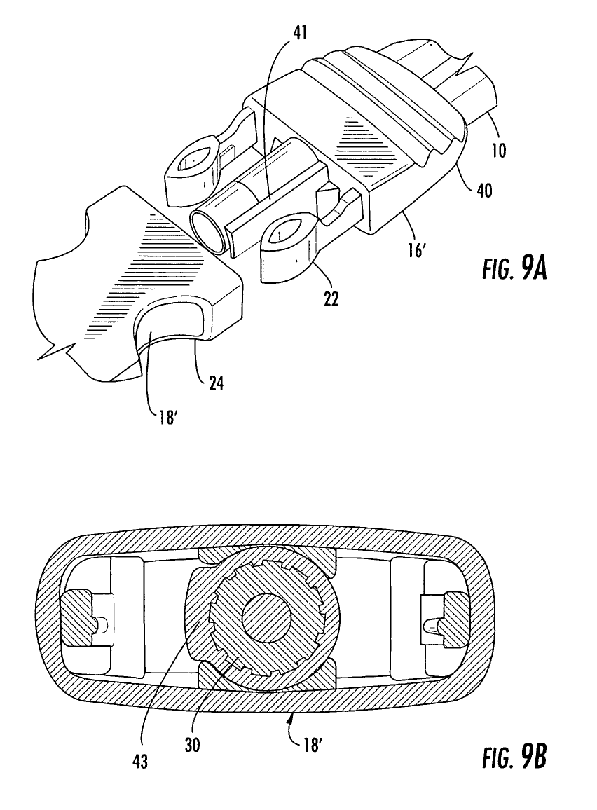

In either the embodiments shown with respect to FIGS. 1-7 or the embodiment shown in FIG. 8, the guide channel of the female fastener portion and the prongs, connector portion, or tang of the male fastener portion can be configured such that the male fastener portion is accepted within the female fastener portion in only one orientation. FIGS. 9A and 9B show one possible example of this arrangement. Here, male fastener portion 16′ includes key 41, FIG. 9A which is received in slot 43, FIG. 9B of female fastener portion 18′ ensuring that male fastener portion 16′, FIG. 9A is received in female fastener part 18′ in only one orientation. Other orientation guiding structures, however, are within the scope of this invention.

FIG. 10 shows extruded plastic female portion 150 of another sliding buckle “Fastex” type connector wherein conductive portion 152 is located in sliding slot tubes 154 of female buckle portion 150 which receive male legs or prongs or plugs 156, FIG. 11 with conductive portions 164 to create circuit connectivity. Recessed tubes 154, FIG. 10 allow legs 156, FIG. 11 to frictionally slide therein and center locking groove 160, FIG. 10 receives center pin 162, FIG. 11 of male member 158. Center locking pin 162, FIG. 11 is received in groove 160, FIG. 10, for secure locking via a friction fit.

Thus, legs 156, FIG. 11 of male portion 158 and tubes 152, FIG. 10 of female portion 150 provide two terminals and, if required, pin 162, FIG. 11 of male portion 158 and receptacle 160, FIG. 10 of female portion 150 can serve as a third terminal.

In another embodiment, the integrated fastener/connector of the subject invention is in the form of a conductive metal snap with a female portion which includes at least one recess and a male portion which includes at least one extension deformably received in the recess of the female portion. Typically, an insulative member associated with both the male and female snap portions divide each into two or more terminals.

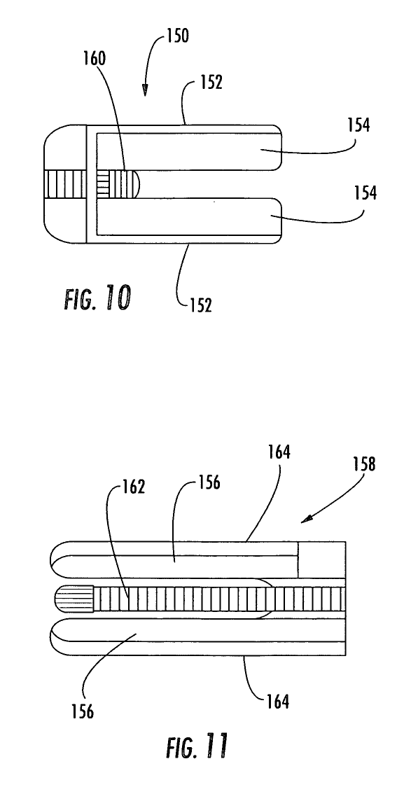

In the example of FIG. 12, conductive snap 200 includes male portion 202 and female portion 204. Male portion 202 includes central extension 206 deformably received in central recess 208 in female portion 204. To provide two separate terminals A and B, FIGS. 13-14, insulator 210, FIG. 12 divides conductive extension 206 of male portion 202 and insulator 212 divides conductive recess 208 of female portion 204.

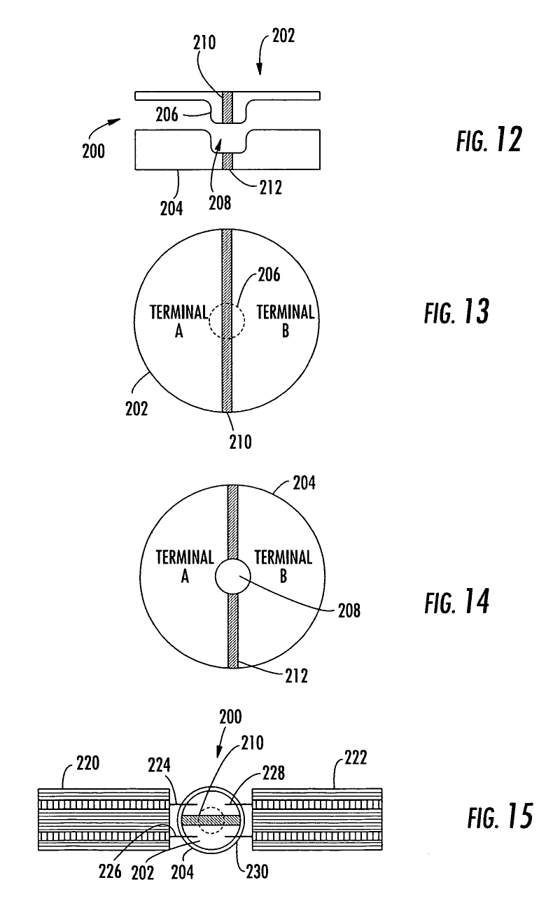

Snap 200, FIG. 15 thus electrically interconnects ribbon 220 with ribbon 222 when male portion 202 is attached to ribbon 220 and transmission elements 224 and 226 thereof are soldered to terminals A and B on opposite sides of insulator 210. Female portion 204 is attached to ribbon 222 and transmission elements 228 and 230 thereof are soldered to terminals A and B, FIG. 14 of female portion 204 on opposite sides of insulator 212.

In this embodiment, extension 206, FIG. 12 is deformably received in recess 208 releasably locking male snap portion 202 with respect to female snap portion 204. The connector is integrated into the male and female portions of the snap by virtue of the conductivity of each snap portion and insulative portion which divides the snap portions into at least two terminals each.

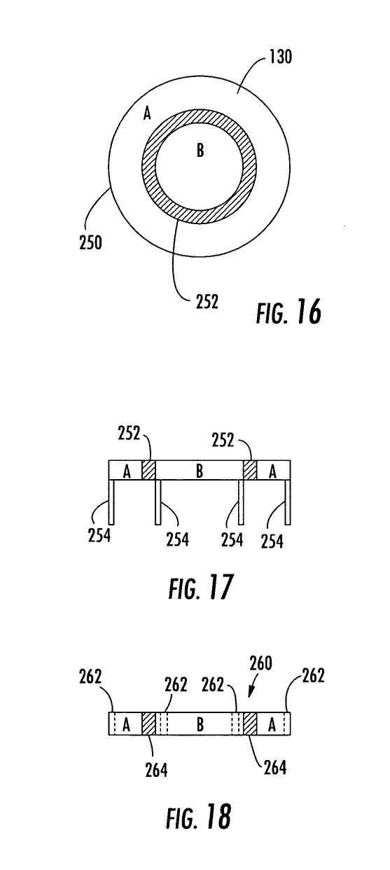

In FIG. 16, conductive male snap portion 250 includes circumferential insulative ring 254 forming terminals A and B. Extensions 254, FIG. 17 are frictionally received within female snap portion 260, FIG. 18, specifically within channels 262. Circumferential insulator 264 divides female snap portion 260 into terminals A and B corresponding to terminals A and B of the male snap counterpart.

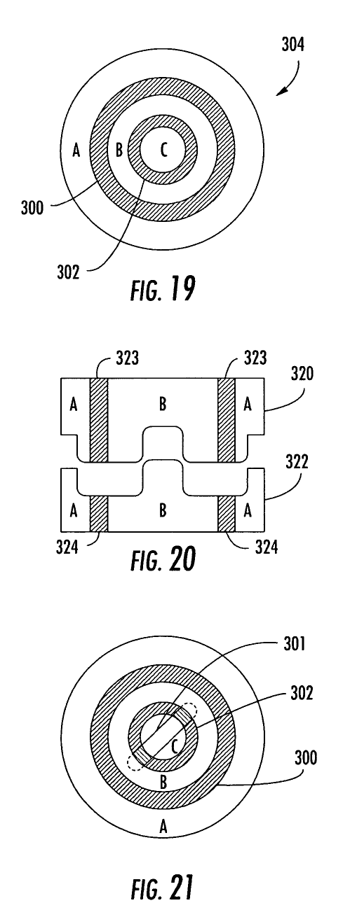

In the embodiment of FIG. 19, co-axial circumferential insulators 300 and 302 of snap portion 304 form three conductive terminals A, B and C. In the embodiment of FIG. 20, “male” snap portion 320 includes conductive terminals A and B separated by insulative ring 323 and “female” snap portion 322 includes corresponding terminals A and B separated by insulative ring 324.

FIGS. 21 and 22 show snap type fastener/connector combinations with a locking mechanism configured to properly orient the male portion of the snap to the female portion of the snap and to secure the data or power connector. In FIG. 21, spring locking device 30 is a slot where the top prongs recess to make a lock for secure connectivity. The other portions of the snap are similar to the snap of FIG. 19 and labeled accordingly. In FIG. 22, locking strip slot 300′ covers the whole snap. As shown at 303, slot 300′ is in the open position to allow the prongs to enter. Slot 301′ returns to the position shown after the prongs have been fully inserted into the bottom rings.

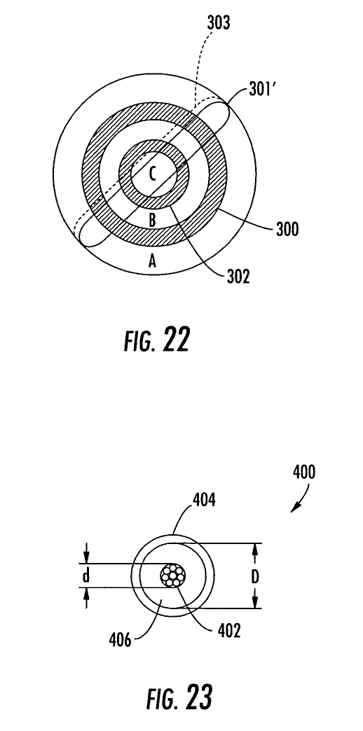

In an other embodiment, both the male and female conductive snap connectors are designed to be impedance controlled (e.g., for low-level signal or high frequency applications). In this embodiment, both the male and female connector have a center conductive pin/receptacle, and a conductive shell (jacket) separated by an insulting dielectric. Male snap member 400, FIG. 23 thus includes center pin 402 and conductive jacket 404 separated by insulating dielectric 406.

The following formula can be used for calculating the characteristic impedance of a coaxial construction:

$$Characteristic Impedance ( Zo ) : Zo = \frac{138}{√ ϵ} \times {Log}_{10} \frac{D}{d} in ohms \qquad ( 1 )$$

Wherein d is the outer diameter of inner (center) conductor 402 (approximate value for stranded), D is the outer diameter of dielectric, and ε=dielectric constant (ε=1 for air).

This equation supports the fact that the characteristic impedance of a coax cable is directly related to the diameter of the conductor and the dielectric. For component video cables, this characteristic impedance should be 75-ohms. With characteristic impedance (Zo) held at a constant 75-ohms, the variables are the diameters and dielectric constant.

The result is the integration of a quick release type fastener with an electrical (or optical) connector. In accordance with any embodiment, the subject invention provides a more durable system quickly connectible and disconnectible without the use of tools and able to facilitate a wide variety of different electrical or optical connectors.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A textile electronic connection system comprising:
a knitted, woven, or braided textile ribbon including integrated transmission elements running the length of the ribbon to transmit data and/or power along the length of the ribbon; and
a fastener for connecting the ribbon to another ribbon or device, the fastener including:
a male portion, and
a female portion,
one of the male portion and the female portion on the ribbon, the other of the male portion and the female portion on the other ribbon or device,
at least one of the male portion and the female portion including a deformable element which releasably locks the male and female portions together; and
a connector integrated with the fastener portions and connected to the integrated transmission elements to quickly allow connection and disconnection of the ribbon to the other ribbon or device in a robust and reliable fashion.

2. The system of claim 1 in which the male portion of the fastener includes deformable prongs and the female portion of the fastener includes recesses which receive the prongs.

3. The fastener of claim 2 in which one portion of the connector is disposed between the deformable prongs of the male portion of the fastener and the other portion of the connector is disposed between the recesses of the female portion of the fastener.

4. The system of claim 3 further including a guide channel in the female portion of the fastener about the connector portion for guiding the connector portions together.

5. The system of claim 4 in which the guide channel is configured to accept the female portion of the connector in only one orientation.

6. The system of claim 4 in which the connector is a USB connector.

7. The system of claim 4 in which the connector is a Lemo connector.

8. The system of claim 2 in which the connector includes conductive portions of the prongs of the male fastener portion and corresponding conductive portions of the female fastener portion.

9. The system of claim 8 further including a pin on the male portion of the fastener and a receptacle in the female portion of the fastener which deformably accepts the pin therein.

10. The system of claim 1 in which the male fastener portion includes a pair of legs and the female fastener portion includes a pair of tubes which receive the legs.

11. The system of claim 10 further including conductive portions on the legs and corresponding conductive portions on the tubes.

12. The system of claim 1 in which the fastener is a conductive snap and the female fastener portion includes at least one recess and the male fastener portion includes at least one extension deformably received in the recess.

13. The system of claim 12 further including at least one insulator dividing the snap into at least two terminals.

14. The system of claim 13 in which there is one centrally located extension and one centrally located recess and the insulator divides the recess into two terminals and the extension into two corresponding terminals.

15. The system of claim 13 in which the male portion includes a circumferential insulator dividing the male portion into inner and outer terminals.

16. The system of claim 15 in which the female portion includes a circumferential insulator dividing the female portion into corresponding inner and outer terminals.

17. The system of claim 16 in which the male portion includes a plurality of extensions, at least two associated with different terminals.

18. The system of claim 17 in which the female portion includes a plurality of recesses each of which accept an extension.

19. The system of claim 13 in which there are a plurality of circumferential insulators coaxially aligned.

20. The system of claim 1 in which the connector includes a portion overmolded onto the ribbon for added durability.

21. A textile electronic connection system comprising:
a male fastener portion including deformable prongs and one portion of a connector between the deformable prongs; and
a female fastener portion including recesses which receive the prongs of the male fastener portion, the female fastener portion includes the other portion of the connector disposed between the recesses of the female fastener portion.

22. A textile electronic connection system comprising:
a male fastener portion including prongs with a conductive portion thereon; and
a female fastener portion including recesses which receive the prongs of the male portion and having corresponding conductive portions contacting the conductive portions of the prongs of the male fastener portion to provide an electrical interconnection between the male and female fastener portions.

23. A textile electronic connection system comprising:
a male fastener portion including legs with the conductive portion thereon; and
a female fastener portion including tubes which receive the legs of the male portion and having corresponding conductive portions contacting the conductive portions of the legs of the male fastener portion to provide an electrical interconnection between the male and female fastener portions.

24. A textile electronic connection system comprising:
a first knitted, woven, or braided textile ribbon including integrated transmission elements running the length of the ribbon to transmit data and/or power along the length of the ribbon;
a second knitted, woven, or braided textile ribbon including integrated transmission elements running the length of the ribbon to transmit data and/or power along the length of the ribbon; and
a fastener for physically and electrically interconnecting the two ribbons, the fastener including:
a male fastener portion on connected to the first ribbon,
a female fastener portion on connected to the second ribbon,
at least one of the male fastener portion and the female fastener portion including a deformable element which locks the male and female portions together,
one connector portion integrated with the male fastener portion and connected to the integrated transmission elements of the first ribbon, and
the other connector portion integrated with the female portion of the fastener and connected to the integrated transmission elements of the second ribbon.

25. A textile electronic connection system comprising:
a first knitted, woven, or braided textile ribbon including integrated transmission elements running the length of the ribbon to transmit data and/or power along the length of the ribbon;
a second knitted, woven, or braided textile ribbon including integrated transmission elements running the length of the ribbon to transmit data and/or power along the length of the ribbon; and
a fastener for physically and electrically interconnecting the two ribbons, the fastener including:
a male fastener portion overmolded onto one end of the first ribbon,
a female fastener portion overmolded onto one end of the second ribbon,
at least one of the male fastener portion and the female fastener portion including a deformable element which locks the male and female portions together,
one connector portion integrated with the male fastener portion and connected to the integrated transmission elements of the first ribbon, and
the other connector portion integrated with the female portion of the fastener and connected to the integrated transmission elements of the second ribbon.

26. A textile electronic connection system comprising:
a first knitted, woven, or braided textile ribbon including integrated transmission elements running the length of the ribbon to transmit data and/or power along the length of the ribbon;
a second knitted, woven, or braided textile ribbon including integrated transmission elements running the length of the ribbon to transmit data and/or power along the length of the ribbon; and
a fastener for physically and electrically interconnecting the two ribbons, the fastener including:
a male fastener portion on connected to the first ribbon and including a pair of deformable prongs,
a female fastener portion on connected to the second ribbon and including a pair of recesses which receive the prongs,
one connector portion between the prongs of the male fastener portion and connected to the integrated transmission elements of the first ribbon, and
the other connector portion between the recesses of the female portion of the fastener and connected to the integrated transmission elements of the second ribbon.

27. A textile electronic connection system comprising:
a first knitted, woven, or braided textile ribbon including integrated transmission elements running the length of the ribbon to transmit data and/or power along the length of the ribbon;
a second knitted, woven, or braided textile ribbon including integrated transmission elements running the length of the ribbon to transmit data and/or power along the length of the ribbon; and
a fastener for physically and electrically interconnecting the two ribbons, the fastener including:
a male fastener portion on connected to the first ribbon and including a pair of deformable prongs,
a female fastener portion on connected to the second ribbon and including a pair of recesses which receive the prongs,
one connector portion on the prongs of the male fastener portion and connected to the integrated transmission elements of the first ribbon, and
the other connector portion integrated with the female portion of the fastener and connected to the integrated transmission elements of the second ribbon.

28. A textile electronic connection system comprising:
a first knitted, woven, or braided textile ribbon including integrated transmission elements running the length of the ribbon to transmit data and/or power along the length of the ribbon;
a second knitted, woven, or braided textile ribbon including integrated transmission elements running the length of the ribbon to transmit data and/or power along the length of the ribbon; and
a fastener for physically and electrically interconnecting the two ribbons, the fastener including:
a male fastener portion on connected to the first ribbon including a pair of legs,
a female fastener portion on connected to the second ribbon including a pair of tubes which receive the legs of the male fastener portion,
one connector portion integrated with the legs of the male fastener portion and connected to the integrated transmission elements of the first ribbon, and
the other connector portion integrated with the tubes of the female portion of the fastener and connected to the integrated transmission elements of the second ribbon.

29. A textile electronic connection system comprising:
a first knitted, woven, or braided textile ribbon including integrated transmission elements running the length of the ribbon to transmit data and/or power along the length of the ribbon;
a second knitted, woven, or braided textile ribbon including integrated transmission elements running the length of the ribbon to transmit data and/or power along the length of the ribbon; and
a fastener for physically and electrically interconnecting the two ribbons, the fastener including:
a male snap member on the first ribbon including an extension,
a female snap member on the second ribbon including a recess which receives the extension of the male snap member,
one connector portion integrated with the male snap member and connected to the integrated transmission elements of the first ribbon, and
the other connector portion integrated with the female snap member of the fastener and connected to the integrated transmission elements of the second ribbon.

30. The system of claim 29 further including an insulator dividing the male snap member, into two terminals and an insulator dividing the female snap member into two terminals.

31. A textile electronic connection system comprising:
a first knitted, woven, or braided textile ribbon including integrated transmission elements running the length of the ribbon to transmit data and/or power along the length of the ribbon;
a second knitted, woven, or braided textile ribbon including integrated transmission elements running the length of the ribbon to transmit data and/or power along the length of the ribbon; and
a fastener for physically and electrically interconnecting the two ribbons, the fastener including:
a male snap portion on the first ribbon,
a female snap portion on the second ribbon,
the male snap portion divided into at least two terminals,
the female snap portion divided into at least two corresponding terminals,
the terminals of the male snap portion connected to the integrated transmission elements of the first ribbon, and
the terminals of the female snap portion connected to the integrated transmission elements of the second ribbon.
